(19) United States
(12) Patent Application Publication
(10) Pub. No.: US 2004/0020337 A1
(43) Pub. Date: Feb. 5, 2004

(54) Wrench having a safety device

(76) Inventor: Chuck Chang, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/614,303

(22) Filed: Jul. 5, 2003

(30) Foreign Application Priority Data
Jul. 5, 2002 (TW) 091115294

(51) Int. Cl. B25B 23/14

(52) U.S. Cl. 81/467

(57) ABSTRACT

A wrench having a safety device includes a shank, a handle slidably mounted on the shank, and at least one resistance member mounted between the shank and the handle to provide a resistance to damp movement of the handle. Thus, when the force applied on the workpiece is increased, the handle is moved on the shank away from the drive head, so that the resistance member is further compressed, and the force arm of the applied force is increased, thereby facilitating the user operating and rotating the workpiece.

### BACKGROUND OF THE INVENTION

1. Field of the Invention

The present invention relates to a wrench having a safety device, and more particularly to a wrench having a safety device that indicates the maximum tolerance torque of the workpiece, so that the applied force is stopped before reaching the preset safety value so as to achieve the safety purpose.

2. Description of the Related Art

A conventional wrench comprises a shank having an end provided with a drive head, and an adjustable torque mechanism mounted in the shank. The adjustable torque mechanism includes a compression spring mounted in the shank and having an end rested on the locking teeth of the drive head. In operation, the torque of the adjustable torque mechanism is preset, so that when the torque of the drive head exerted on a workpiece exceeds the preset value during operation of the wrench, the locking teeth of the drive head slip, so that the drive head cannot operate the workpiece, thereby providing a safety effect. However, the adjustable torque mechanism is hidden in the shank, so that the user cannot observe operation of the adjustable torque mechanism and easily exerts an excessive force on the wrench, thereby wearing the locking teeth of the drive head.

### SUMMARY OF THE INVENTION

The present invention is to mitigate and/or obviate the disadvantage of the conventional wrench.

The primary objective of the present invention is to provide a wrench having a safety device, wherein the size indication mark indicates the maximum tolerance torque of the workpiece to limit the range of the applied force, so that the applied force is stopped before reaching the preset safety value, thereby preventing the workpiece from being broken, so as to achieve the safety purpose.

Another objective of the present invention is to provide a wrench having a safety device, wherein the wrench comprises a resistance member mounted between the shank and the handle, so that the wrench has a simplified structure, thereby decreasing costs of fabrication.

A further objective of the present invention is to provide a wrench having a safety device, wherein when the force applied on the workpiece is increased, the handle is moved on the shank away from the drive head, so that the resistance member is further compressed, and the force arm of the applied force is increased, thereby facilitating the user operating and rotating the workpiece.

A further objective of the present invention is to provide a wrench having a safety device, wherein the size indication mark simultaneously indicates the maximum tolerance torque of the workpiece during movement of the handle, thereby facilitating the user operating the workpiece.

In accordance with the present invention, there is provided a wrench, comprising:

a shank;

a handle slidably mounted on the shank; and

at least one resistance member mounted between the shank and the handle to provide a resistance to damp movement of the handle.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a wrench having a safety device in accordance with the preferred embodiment of the present invention;

FIG. 2 is an exploded perspective view of the wrench having a safety device in accordance with the preferred embodiment of the present invention;

FIG. 3 is a partially cut-away plan cross-sectional view of the wrench having a safety device as shown in FIG. 1;

FIG. 4 is a top plan operational view of the wrench having a safety device as shown in FIG. 1;

FIG. 5 is an operational view of the wrench having a safety device as shown in FIG. 3;

FIG. 6 is a partially cut-away plan cross-sectional operational view of the wrench having a safety device as shown in FIG. 1;

FIG. 7 is a schematic view of the operational track of the wrench having a safety device as shown in FIG. 1;

FIG. 8 is a partially cut-away plan cross-sectional view of the wrench in accordance with another embodiment of the present invention;

FIG. 9 is a partially cut-away plan cross-sectional view of the wrench in accordance with another embodiment of the present invention;

FIG. 10 is a partially cut-away plan cross-sectional view of the wrench in accordance with another embodiment of the present invention;

FIG. 11 is a partially cut-away plan cross-sectional view of the wrench in accordance with another embodiment of the present invention;

FIG. 12 is a perspective view of the wrench in accordance with another embodiment of the present invention;

FIG. 13 is a perspective view of the wrench in accordance with another embodiment of the present invention;

FIG. 14 is a partially cut-away plan cross-sectional view of the wrench in accordance with another embodiment of the present invention;

FIG. 15 is a perspective view of the wrench in accordance with another embodiment of the present invention; and

FIG. 16 is a partially cut-away plan cross-sectional view of the wrench in accordance with another embodiment of the present invention.

### DETAILED DESCRIPTION OF THE INVENTION

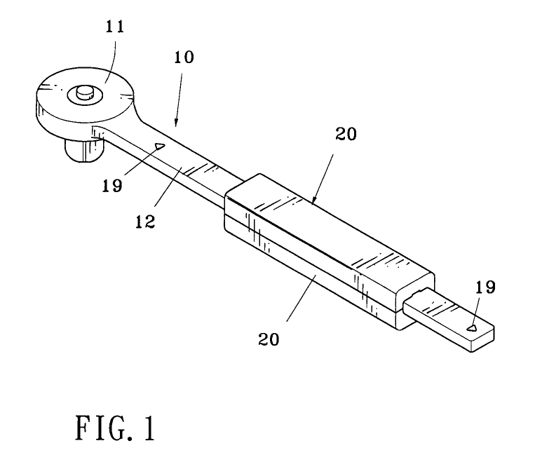

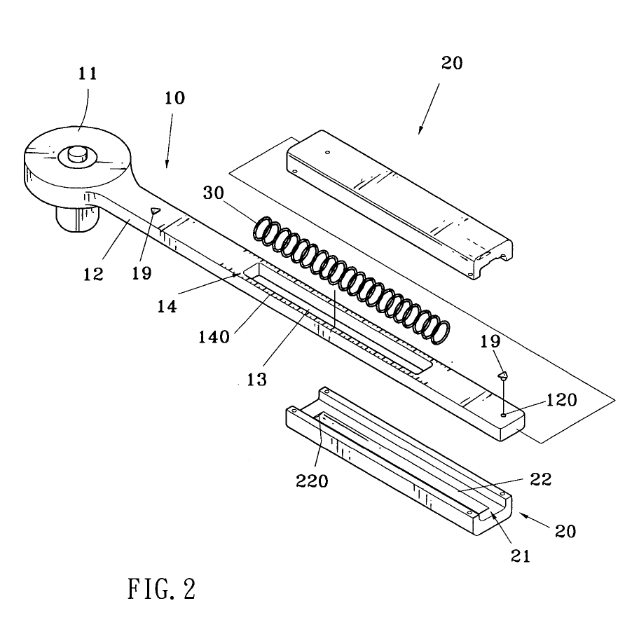

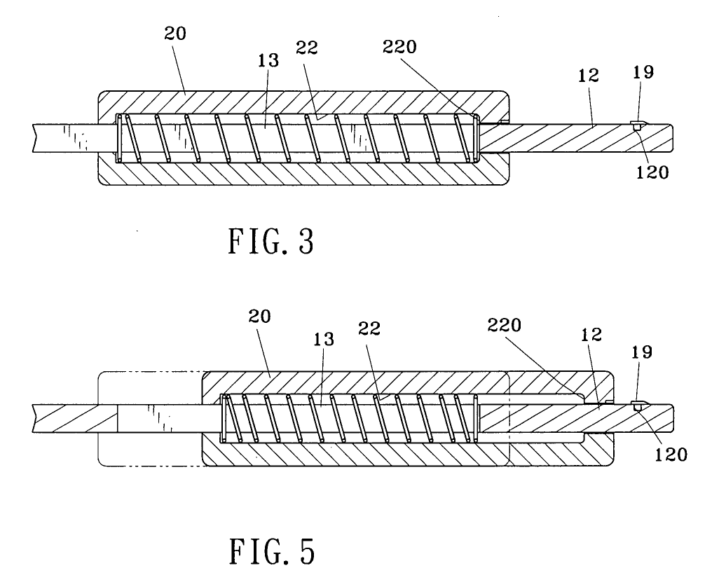

Referring to the drawings and initially to FIGS. 1-5, a wrench 10 having a safety device in accordance with the preferred embodiment of the present invention comprises a shank 12 having an end provided with a drive head 11, a handle 20 slidably mounted on the shank 12, and a resistance member 30 mounted between the shank 12 and the handle 20 to provide a resistance to damp movement of the handle 20.

In operation, when a force is applied on the handle 20 to rotate the shank 12 about the drive head 11, the force produces an axial component force which drives the handle 20 to move relative to the shank 12, so that the resistance member 30 is compressed, and the handle 20 is moved on the shank 12 to a determined position.

In addition, the shank 12 is formed with an elongated receiving slot 13 to receive the resistance member 30. Preferably, the shank 12 is provided with an indication portion 14 having a plurality of size indication marks 140 to indicate the safety parameters of motion of the handle 20, thereby providing a safety effect. In addition, the indication portion 14 is located adjacent to the receiving slot 13 of the shank 12. The size indication mark 140 indicates the maximum torque tolerance of the workpiece driven by the drive head 11, and the position of the size indication mark 140 is measured corresponding to the applied force.

Preferably, the resistance member 30 is a compression spring. In addition, the resistance member 30 is mounted in the receiving slot 13 of the shank 12 and has a top portion and a bottom portion each protruded outward from the receiving slot 13 of the shank 12 and each locked in the handle 20.

The handle 20 includes two covers 21 combined with each other and each slidably mounted on the shank 12. Each of the two covers 21 of the handle 20 is formed with a semi-circular receiving groove 22 to receive the top portion and the bottom portion of the resistance member 30 respectively. Preferably, the receiving groove 22 of each of the two covers 21 of the handle 20 has two closed ends each provided with a resting portion 220 to retain an end of the resistance member 30.

In addition, the shank 12 has two ends each provided with a protruding stop mark 19 to limit movement of the handle 20. Preferably, each of the two ends of the shank 12 is formed with a positioning hole 120 for positioning the respective stop mark 19.

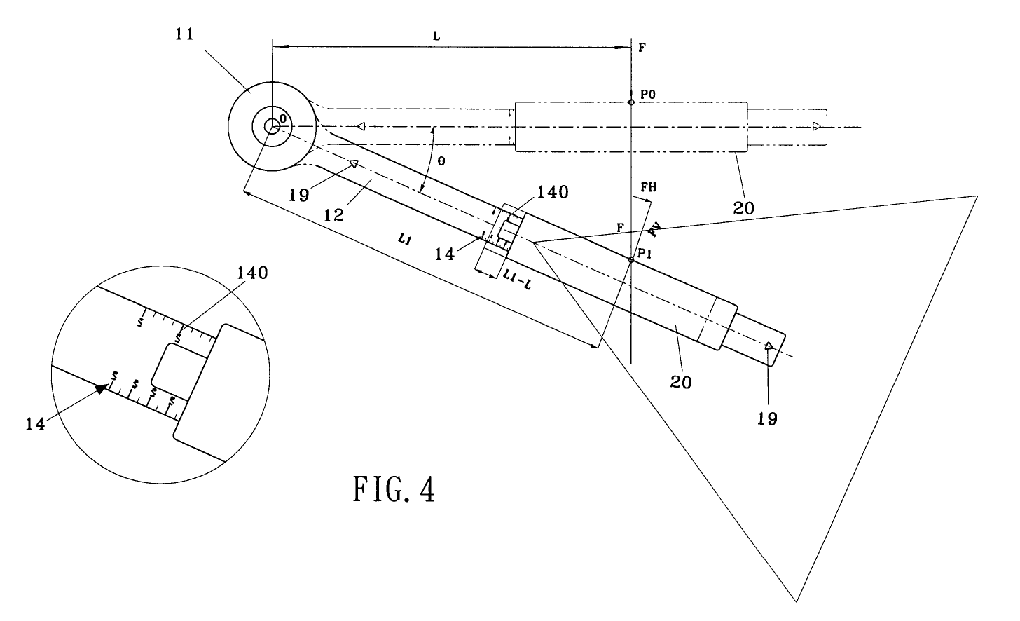

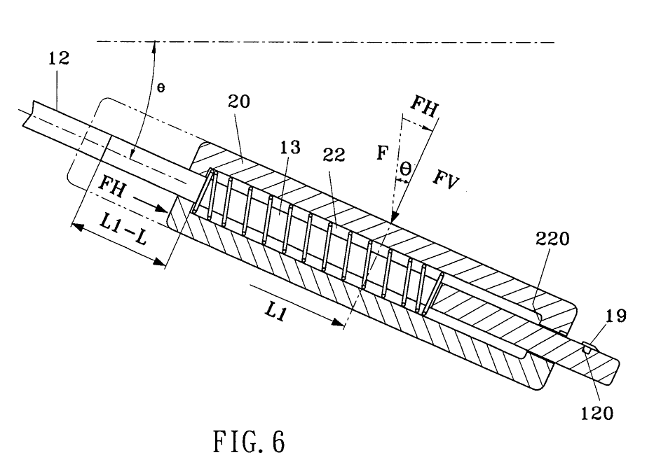

In practice, referring to FIGS. 4-7 with reference to FIGS. 1-3, when a force F (the force F is vertical to the center of the handle 20) is applied on the handle 20 to rotate the shank 12 about the center O of the drive head 11 through an inclined angle θ, the force F produces an axial component force FH and a vertical component force FV. Thus, the axial component force FH drives the handle 20 to move on the shank 12 away from the drive head 11, so that the resistance member 30 is compressed, and the applied force arm of the force F is increased from L to L1.

When the track of the handle 20 is moved from P0 to P1 to reach the rated force of the force F, the size indication mark 140 indicates the maximum torque tolerance of the workpiece driven by the drive head 11. At this time, the maximum torque tolerance of the workpiece is equal to the vertical component force FV multiplying the applied force arm L1 (FV*L1). The axial component force FH is proportional to the compressed value of the resistance member 30. Thus, by calculation of the compressed value of the resistance member 30, the axial component force FH and the vertical component force FV can be calculated, so that the value of the force F can be calculated and the position of the size indication mark 140 is calculated so as to indicate the value of the force F. Thus, the position of the size indication mark 140 is indicated.

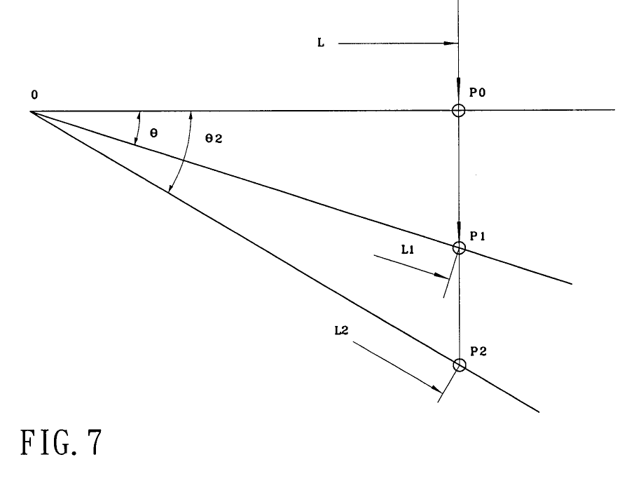

If the applied force is smaller than the force F, the position of the size indication mark 140 will not appear, and if the applied force is greater than or equal to the force F, the position of the size indication mark 140 will be indicated. Thus, when the rated tolerance of the force F is not reached, the shank 12 is rotated about the center O of the drive head 11 through an inclined angle θ2, and the track of the handle 20 is still moved to P2 to reach the applied force arm L2 as shown in FIG. 7.

Accordingly, the wrench 10 in accordance with the preferred embodiment of the present invention has the following advantages.

1. The size indication mark 140 indicates the maximum tolerance torque of the workpiece to limit the range of the applied force, so that the applied force is stopped before reaching the preset safety value, thereby preventing the workpiece from being broken, so as to achieve the safety purpose.

2. The wrench 10 comprises a resistance member 30 mounted between the shank 12 and the handle 20, so that the wrench 10 has a simplified structure, thereby decreasing costs of fabrication.

3. When the force applied on the workpiece is increased, the handle 20 is moved on the shank 12 away from the drive head 11, so that the resistance member 30 is further compressed, and the force arm of the applied force is increased, thereby facilitating the user operating and rotating the workpiece.

4. The size indication mark 140 simultaneously indicates the maximum tolerance torque of the workpiece during movement of the handle 20, thereby facilitating the user operating the workpiece.

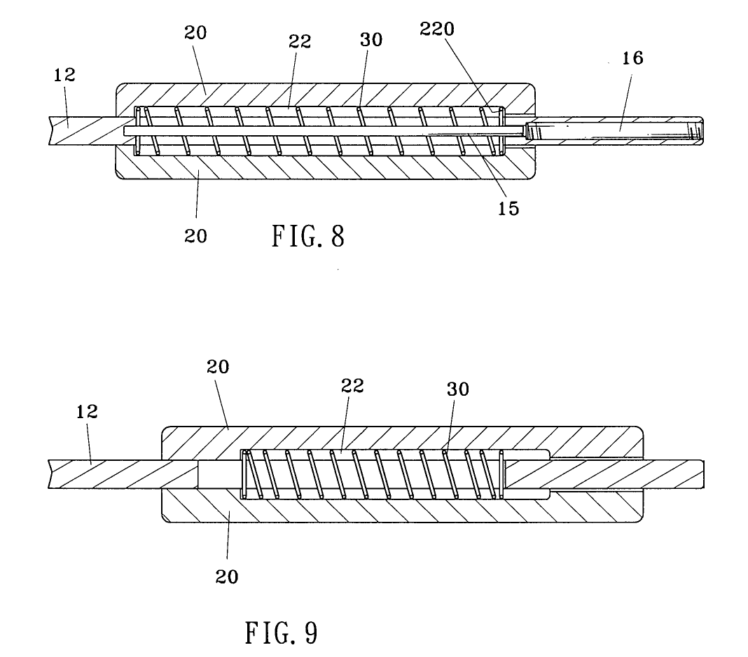

Referring to FIG. 8, the wrench further comprises a support member 15 mounted in the resistance member 30 and extended through the shank 12 to prevent deformation the resistance member 30 when being compressed, and a locking member 16 mounted on a distal end of the shank 12 to lock the support member 15.

Referring to FIG. 9, the length of the receiving slot 13 of the shank 12 is smaller than that of the indication portion 14, thereby preventing the receiving slot 13 from being exposed outward during movement of the handle 20.

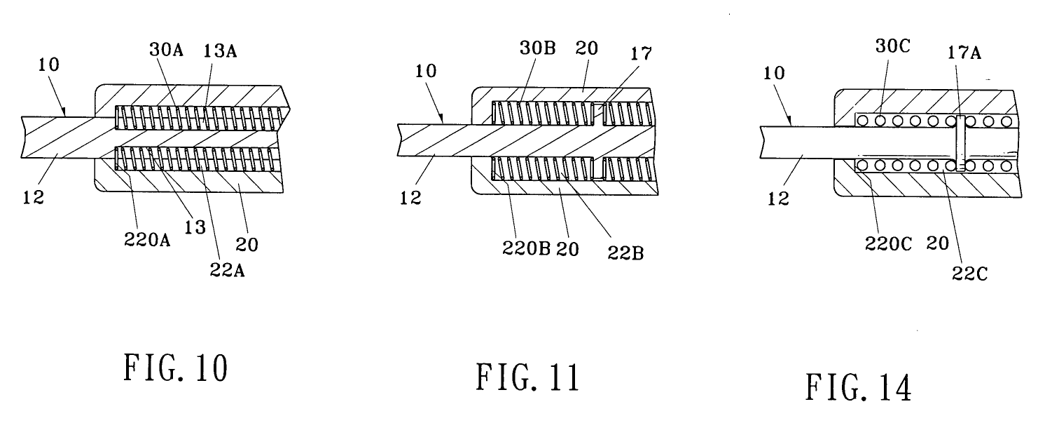

Referring to FIG. 10, the shank 12 is formed with two opposite semi-circular receiving channels 13A, the handle 20 is formed with two opposite semi-circular receiving grooves 22A, and the wrench comprises two resistance members 30A each mounted between a respective one of the two receiving channels 13A of the shank 12 and a respective one of the two receiving grooves 22A of the handle 20.

Referring to FIG. 11, the handle 20 is formed with two opposite semi-circular receiving grooves 22B, the shank 12 is formed with a protruding resting portion 17 extending into the two receiving grooves 22B of the handle 20, and the wrench comprises two resistance members 30B each mounted in a respective one of the two receiving grooves 22B of the handle 20 and each urged on the resting portion 17 of the shank 12.

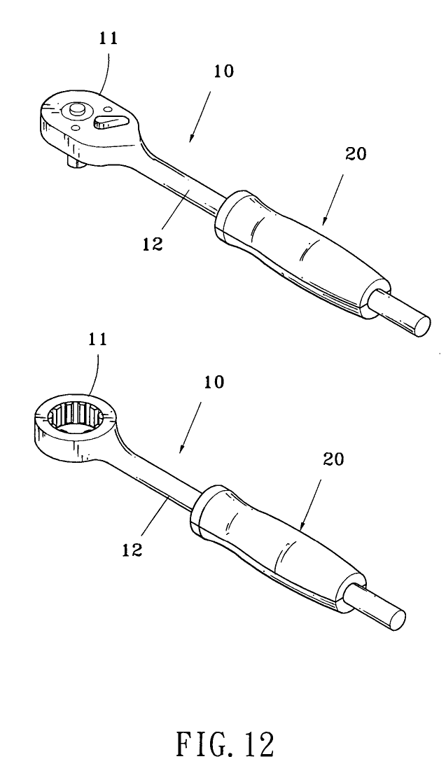

Referring to FIG. 12, the handle 20 is mounted on a ratchet wrench.

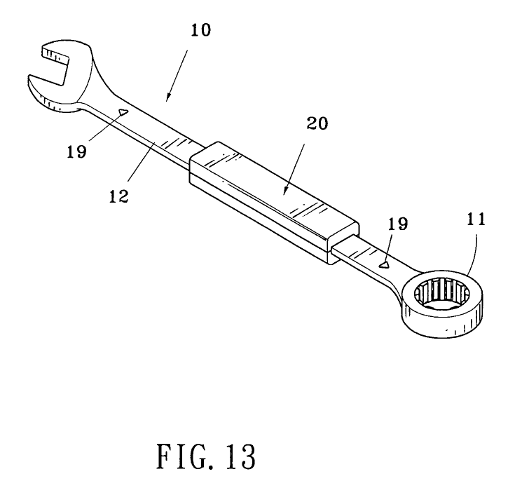

Referring to FIG. 13, the handle 20 is mounted on a combination wrench.

Referring to FIG. 14, the handle 20 is formed with two opposite semi-circular receiving grooves 22C, the shank 12 is formed with a protruding resting portion 17A extending into the two receiving grooves 22C of the handle 20, and the wrench comprises a resistance members 30C mounted in the receiving grooves 22C of the handle 20 and urged on the resting portion 17A of the shank 12.

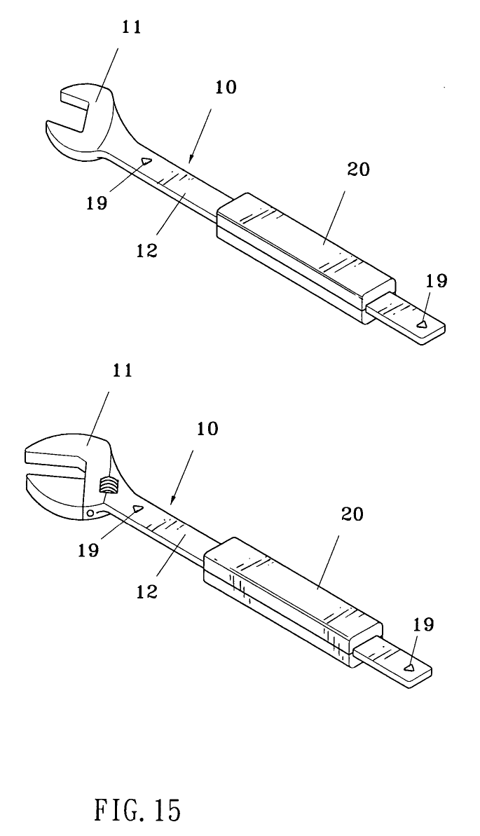

Referring to FIG. 15, the handle 20 is mounted on an open-ended wrench.

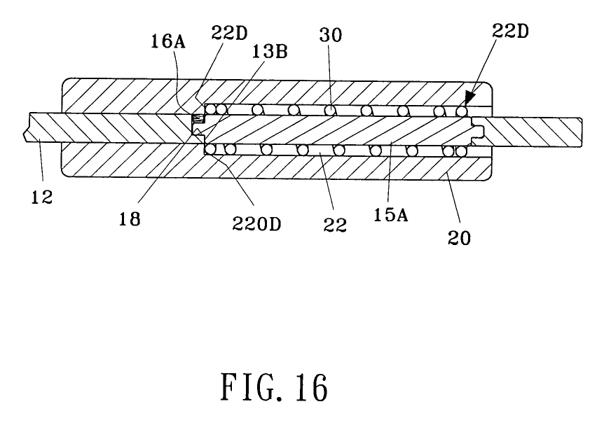

Referring to FIG. 16, the receiving slot 13B of the shank 12 has two ends each formed with a recessed locking portion 18, and the wrench further comprises a support member 15A mounted in the resistance member 30 and having two ends each locked in the locking portion 18 of the receiving slot 13B of the shank 12 by a locking member 16A. Preferably, the receiving groove 22D of the handle 20 has a closed end and an opened end, wherein the closed end is provided with a resting portion 220D to retain an end of the resistance member 30.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A wrench, comprising:
a shank;
a handle slidably mounted on the shank; and
at least one resistance member mounted between the shank and the handle to provide a resistance to damp movement of the handle.

2. The wrench in accordance with claim 1, wherein the shank has an end provided with a drive head.

3. The wrench in accordance with claim 2, wherein when a force is applied on the handle to rotate the shank about the drive head, the force produces an axial component force which drives the handle to move relative to the shank, so that the resistance member is compressed, and the handle is moved on the shank to a determined position.

4. The wrench in accordance with claim 1, wherein the shank is provided with an indication portion having a plurality of size indication marks to indicate safety parameters of motion of the handle during movement of the handle.

5. The wrench in accordance with claim 1, wherein the shank is formed with an elongated receiving slot to receive the resistance member.

6. The wrench in accordance with claim 5, wherein the shank is provided with an indication portion located adjacent to the receiving slot of the shank.

7. The wrench in accordance with claim 5, wherein the resistance member has a top portion and a bottom portion each protruded outward from the receiving slot of the shank and each locked in the handle.

8. The wrench in accordance with claim 7, wherein the handle is formed with two semi-circular receiving grooves to receive the top portion and the bottom portion of the resistance member respectively.

9. The wrench in accordance with claim 8, wherein each of the receiving grooves of the handle has two closed ends each provided with a resting portion to retain an end of the resistance member.

10. The wrench in accordance with claim 1, wherein the shank has two ends each provided with a protruding stop mark to limit movement of the handle.

11. The wrench in accordance with claim 10, wherein each of the two ends of the shank is formed with a positioning hole for positioning the respective stop mark.

12. The wrench in accordance with claim 1, further comprising a support member mounted in the resistance member and extended through the shank to prevent deformation the resistance member when being compressed, and a locking member mounted on a distal end of the shank to lock the support member.

13. The wrench in accordance with claim 5, wherein the receiving slot of the shank has a length smaller than that of the indication portion, thereby preventing the receiving slot from being exposed outward during movement of the handle.

14. The wrench in accordance with claim 1, wherein the shank is formed with two opposite semi-circular receiving channels, the handle is formed with two opposite semi-circular receiving grooves, and the wrench comprises two resistance members each mounted between a respective one of the two receiving channels of the shank and a respective one of the two receiving grooves of the handle.

15. The wrench in accordance with claim 1, wherein the handle is formed with two opposite semi-circular receiving grooves, the shank is formed with a protruding resting portion extending into the two receiving grooves of the handle, and the wrench comprises two resistance members each mounted in a respective one of the two receiving grooves of the handle and each urged on the resting portion of the shank.

16. The wrench in accordance with claim 1, wherein the handle is formed with two opposite semi-circular receiving grooves, the shank is formed with a protruding resting portion extending into the two receiving grooves of the handle, and the resistance members is mounted in the receiving grooves of the handle and urged on the resting portion of the shank.

17. The wrench in accordance with claim 5, wherein the receiving slot of the shank has two ends each formed with a recessed locking portion, and the wrench further comprises a support member mounted in the resistance member and having two ends each locked in the locking portion of the receiving slot of the shank by a locking member.

18. The wrench in accordance with claim 17, wherein the handle is formed with two opposite semi-circular receiving grooves each having a closed end and an opened end, and the closed end is provided with a resting portion to retain an end of the resistance member.
